(19) United States
(12) Patent Application Publication
(10) Pub. No.: US 2007/0124068 A1
(43) Pub. Date: May 31, 2007

(54) Route guidance system and route guidance method

(75) Inventors: Takaaki Nakayama, Okazaki-shi (JP); Shino Oonishi, Okazaki-shi (JP); Kensuke Takeuchi, Okazaki-shi (JP); Kiyohide Kato, Okazaki-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 11/605,258

(22) Filed: Nov. 29, 2006

(30) Foreign Application Priority Data
Nov. 30, 2005 (JP) 2005-346789

(51) Int. Cl. G01C 21/00

(52) U.S. Cl. 701/210; 701/200

(57) ABSTRACT

A route guidance system includes a current-location detecting unit for detecting the current location of the vehicle; a route-searching unit for searching to determine a route to a destination from the detected vehicle current location; a guidance-intersection setting processing unit for setting a guidance intersection based on the determined route; a route guidance point setting processing unit for setting a route guidance point on the near side of a guidance intersection; a change condition determination processing unit for calculating a route guidance region from the start to the end of route guidance based on the route guidance point and the contents of route guidance, and determining whether or not the route guidance region overlaps a predetermined intersection between the vehicle current location and the guidance intersection; and a route guidance region changing unit for changing the route guidance region when the route guidance region is determined to overlap the predetermined intersection.

### INCORPORATION BY REFERENCE

The disclosure of Japanese Patent Application No. 2005-346789 filed on Nov. 30, 2005, including the specification, drawings and abstract thereof, is incorporated by reference herein in its entirety.

### BACKGROUND OF THE INVENTION

1. Field of the Invention

The present invention relates to a route guidance system and to a route guidance method.

2. Description of the Related Art

In a navigation system with provision for detection of the current location of a vehicle by GPS (Global Positioning System), after detection of the current location, map data is read out from a data recording unit, a map screen is displayed on a display unit, and the current location of the user's vehicle, a map of the area around the vehicle, and so forth are displayed on this map screen. Accordingly, a driver can drive a vehicle guided by display of the vehicle location on the map screen.

When the driver has input a destination and set search conditions, route-searching is executed in accordance with the input search conditions, and a route from a departure location or from the current location to the destination is determined. Subsequently, the route which has been determined by the search is displayed on the map screen together with the user's vehicle location, and guidance along the determined route, i.e., route guidance, is output, thus assisting the driver in driving the vehicle along the determined route.

In such a route guidance system, when it becomes necessary to turn the vehicle to the right or left at a predetermined intersection (“guidance intersection”), before the vehicle reaches the intersection, audio (voice) route guidance is output. Accordingly, one or more route guidance points are set at points spaced from the guidance intersection by a predetermined distance before the guidance intersection on the determined route, and upon the vehicle reaching each of the route guidance points, guidance of a content set beforehand for each of the route guidance points is output by voice (e.g., see Japanese Unexamined Patent Application Publication No. 6-295399)

However, with the above described conventional navigation device, each of the route guidance points is uniformly set based on a distance from the guidance intersection, so there may be cases wherein, upon the vehicle driving through an intersection on the near side of the guidance intersection while route information for the guidance intersection is being output, the number of roads intersecting the guidance route, i.e. intersections reached before the guidance intersection, and the number of roads mentioned in the guidance will not match.

FIGS. 2, 3 and 4 illustrate operation of a conventional route guidance system.

In FIGS. 2, 3 and 4, ri (i=1, 2, . . . ) represent roads, and crj (j=1, 2, . . . ) represent intersections, with roads r1 and r2 intersecting at intersection cr1, roads r1 and r3 intersecting at intersection cr2, roads r1 and r4 intersecting at intersection cr3, and roads r1 and r5 intersecting at intersection cr4. Rt represents the route determined by search, which route Rt passes over the road r1, turns left at intersection cr4, and turns off to road r5, the intersection cr4 having been set as guidance intersection c1. Also, pr represents the user's vehicle location, and h1 represents the route guidance point.

Upon the vehicle reaching the route guidance point h1, route guidance is output by voice for the guidance intersection c1, in the form preset message.

In this case, a route guidance region AR1 is established as a region extending from a route guidance start point s1 where the route guidance starts, to a route guidance end point e1 where the route guidance ends. Note that the distance over which the route guidance region AR1 extends can be calculated based on the time from start to end of the route guidance (play time of the audio message), and the vehicle speed.

FIG. 2 shows the route guidance start point s1 set at the near side of the intersection cr2, and the route guidance end point e1 set beyond the intersection cr2. Upon the vehicle reaching the route guidance point h1, a message such as “Soon, turn left at the third road” or the like is output.

FIG. 3 shows the route guidance start point s2 set within the intersection cr2, and the route guidance end point e2 set beyond the intersection cr2. Upon the vehicle reaching the route guidance point h1, a message such as “Soon, turn left at the second road” or the like is output.

Finally, in FIG. 4, the route guidance start point s3 is set at the near side of the intersection cr2, and the route guidance end point e3 is set within the intersection cr2. Upon the vehicle reaching the route guidance point h1, a message such as “soon, turn left at the third road” or the like is output.

In using the above-described system, there may be instances wherein the vehicle will be traveling through the intersection cr2 while the route guidance is being output, which may result in the number of intersecting roads (intersections) passed in approaching the guidance intersection c1, as recognized by the driver, not matching the number of roads referred to in the route guidance.

Accordingly, in such a situation a vehicle cannot be driven along the searched route in a sure manner by following the route guidance.

### SUMMARY OF THE INVENTION

Accordingly, it is an object of the present invention to solve the above-described problems of conventional navigation devices by providing a route guidance system and a route guidance method whereby a vehicle can be driven along a route determined by navigational searching, in a sure manner, by following route guidance at each route guidance point.

To this end, the route guidance system according to the present invention comprises: a current-location detecting unit for detecting the current location of the user's vehicle; route-searching means for searching for a route to a destination based on the detected vehicle current location; guidance-intersection setting means for setting a guidance intersection based on the route determined by the searching; route guidance point processing means for setting a route guidance point at a point located a predetermined distance on the near side of a guidance intersection, set for initiation of route guidance pertaining to the guidance intersection; route guidance region determination means for calculating a route guidance region from the start to the end of route guidance based on the position of the set route guidance point and the contents of the route guidance, and for determining whether or not the route guidance region overlaps a predetermined intersection between the detected vehicle location and the guidance intersection; and region route guidance changing means for changing the route guidance region in the event that the route guidance region is determined to overlap the predetermined intersection.

According to the present invention, a route guidance region from the start to the end of route guidance is calculated, and in the event that the route guidance region overlaps the predetermined intersection between the detected vehicle location and the guidance intersection, the route guidance region is changed, thereby eliminating the possibility that the vehicle may be passing through an intersection on the near side of a guidance intersection while route guidance for the guidance intersection is being output. Accordingly, the number of branch (intersecting) roads passed in route to the guidance intersection which the driver recognizes, and the number of branch roads identified in route guidance will match. Consequently, the vehicle can be driven along the determined route, through closely spaced intersections, in a reliable manner by following the route guidance.

### BRIEF DESCRIPTION OF THE DRAWINGS

FIG. 1A is a diagram illustrating a navigation system according to an embodiment of the present invention; and FIG. 1B is a functional, block diagram of the computer 31 in FIG. 1A.

FIG. 2 is a first diagram illustrating conventional route guidance for an intersection.

FIG. 3 is a second diagram illustrating conventional route guidance for an intersection.

FIG. 4 is a third diagram illustrating conventional route guidance for an intersection.

FIG. 5 is a flowchart of a preferred embodiment of the method of the present invention.

FIG. 6 is a first diagram illustrating an example of route guidance according to an embodiment of the present invention.

FIG. 7 is a second diagram illustrating an example of route guidance according to an embodiment of the present invention.

### DESCRIPTION OF THE PREFERRED EMBODIMENTS

An embodiment of the present invention will now be described in detail with reference to the drawings, wherein a navigation system serves as the route guidance system.

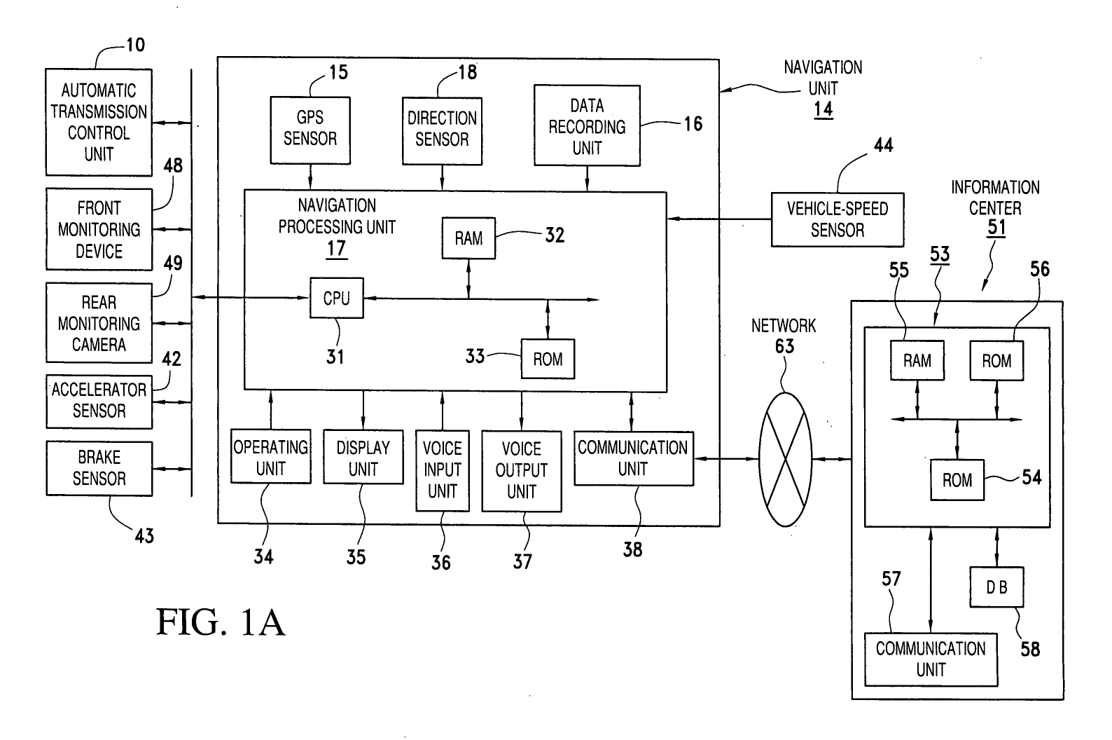

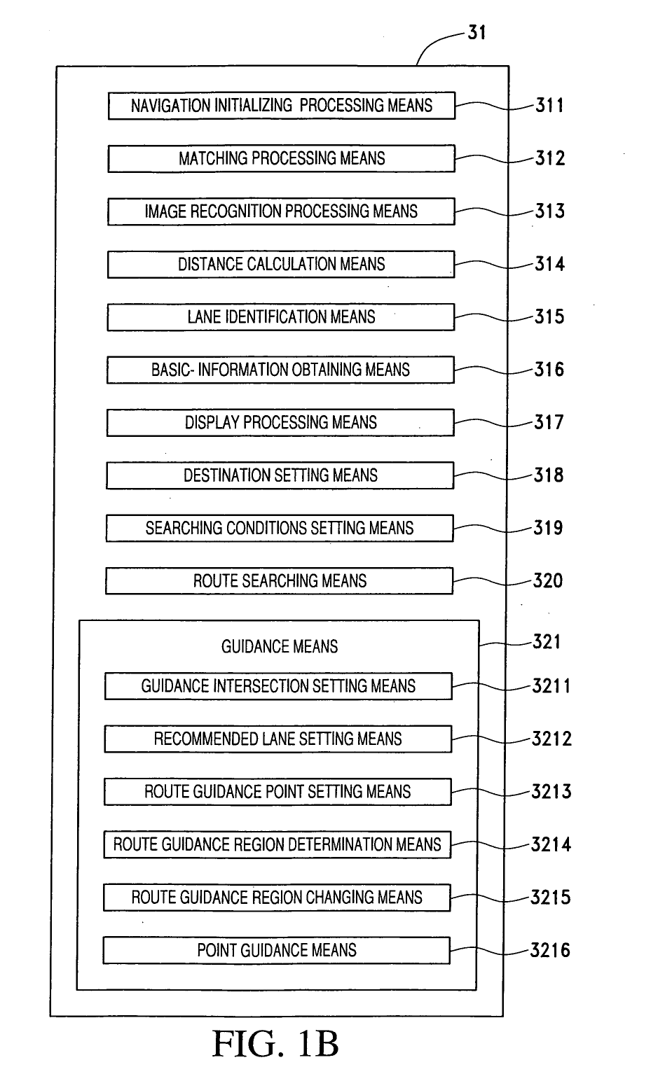

FIG. 1A is a diagram illustrating a navigation system according to a first embodiment of the present invention.

FIG. 1A shows an automatic transmission control unit 10 serving as a power train control unit, and this automatic transmission control unit 10 controls gear shifting between predetermined gear ratios of, for example, a continuously variable transmission (CVT) serving as a non-step transmission, a stepped transmission (automatic transmission), or an electric drive.

The navigation system includes an information terminal 14, for example an on-board navigation device, a network 63, and an information center information provider 51.

The navigation device 14 has a GPS sensor 15 serving as a current location detecting unit for detecting the current location of the vehicle, a data recording unit 16 serving as an information recording unit wherein various information other than map data is recorded, a navigation processing unit 17 for executing various programs such as navigation programs and the like based on input information, a direction sensor 18 serving as a direction detecting unit which detects the direction of the vehicle, an operating unit 34 serving as a first input unit which allows the driver (operator) to input information, a display unit 35 serving as a first output unit for assisting, e.g. guiding the driver, by display of various images on a display screen (not shown), a voice input unit 36 serving as a second input unit and allowing the driver to input information by voice, a voice output unit 37 serving as a second output unit for assisting, e.g. guiding, the driver by voice, and a communication terminal 38 serving as a transmitting/receiving unit, all of which are connected to the navigation processing unit 17.

Also, the navigation processing unit 17 is connected to the automatic transmission control unit 10, a front monitoring device 48 which is attached at a predetermined location on the front end of the vehicle, for monitoring to the front of the vehicle, a rear monitoring camera (image-capturing device) 49 which is attached at a predetermined location on the rear end of the vehicle, for photographing to the rear of the vehicle, an accelerator sensor 42 serving as an engine load detecting device for detecting the operation of the accelerator pedal by the driver, i.e. the degree of opening of the accelerator, a brake sensor 43 serving as a control detecting unit for detecting the operation of the brake pedal by the driver, i.e. the degree of depression of the brake pedal, a vehicle speed sensor 44 for detecting the vehicle speed, and so forth. The accelerator sensor 42, brake sensor 43 and so forth constitute the operating information detecting unit for detecting operating information pertaining to operation of the vehicle by the driver. Instead of rear monitoring camera 49, various types of cameras can be used as imaging devices, such as a front camera for the purpose of monitoring to the front of the vehicle or a side camera for the purpose of monitoring to the side of the vehicle.

The GPS sensor 15 detects the current location by receiving radio signals from a satellite, and also detects the time of day. In the preferred embodiment of the present invention, a GPS sensor 15 is used as the current location detecting unit, but instead of this GPS sensor 15, a distance sensor, steering sensor, altimeter and so forth can be used individually or in combination. Also, a gyro sensor, geomagnetic sensor or the like can be used as the direction sensor 18. Note that while the present embodiment has been described as including a direction sensor 18, vehicle speed sensor 44, and so forth, a GPS sensor may provide the function of detecting vehicle direction and vehicle speed, in which case the direction sensor 18 and vehicle speed sensor 44 are not needed.

The data recording unit 16 has a map database with map data files wherein map data is recorded. This map data includes intersection data relating to intersections, node data relating to nodes, road data related to road links, search data which is processed for searching, and facility data relating to facilities, as well as including object feature data relating to features of objects on and along side the road.

The object features may include features of displays installed on or along roads for providing various types of information to a driver, or for providing various types of guidance, and include display lines, road signs, pedestrian crossings, manhole covers, traffic signals, and so forth. The display lines include stop lines on the road for stopping vehicles, vehicular lane lines for delimiting each lane, lines indicating parking spaces, and so forth. The road signs include traffic classification signs indicating the travel direction of each lane, using an arrow, and guidance signs for announcing a temporary stop beforehand, such as “STOP”, guiding directions such as “turn here to go to so-and-so” and the like. The object feature data includes position information which identifies the position of each object as coordinates or the like, image information representing each object with an image, and so forth. The “temporary stop” may be an entrance point to a right-of-way road from a non-right-of-way road, railroad crossings, intersections with a red signal blinking, and so forth.

Also, the road data relating to lanes may include lane data made up of lane numbers assigned to each lane of a road, lane position information, etc. Data for outputting predetermined information by voice, using the voice output unit 37, is also recorded in the data recording unit 16.

The data recording unit 16 may be used to form a statistics database made up of statistical data files and/or a driving history database made up of driving history data files. Statistical data is recorded in the statistical data files, and driving history data is recording in the driving history data files.

The statistical data is a record of traffic information provided in the past, i.e., information representing traffic history, which is traffic information provided in the past by a road traffic information center or the like, such as the VICS (Vehicle Information and Communication System) center, road traffic census information, i.e. data for the history of traffic volume, e.g., the road traffic census provided by the Ministry of Land, Infrastructure and Transport, the road time-table information provided by the Ministry of Land, Infrastructure and Transport, independently, or in combination. The statistical data can be supplemented with heavy traffic forecast information, etc. In this latter case, when creating the statistical data, detailed conditions such as date and time, day of the week, weather, various types of events, season, information regarding facilities (existence of large-sized facilities such as a department stores, supermarkets, and so forth), are added to the history information.

Also, the data items of the statistical data may include a link number for each of the road links, a direction flag indicating the direction of travel, information classification indicating the type of information, the degree of heavy traffic at predetermined times, link travel time indicating a travel time predetermined for each of the road links, average data for all days of the week for the link travel time, e.g., day-of-the-week average data, and so forth.

The driving history data, which is collected from multiple vehicles, i.e., the user's vehicle and/or the other vehicles, by the information center 51, is information for the vehicle driving records on the roads traveled by each of the vehicles, i.e., driving record, which is calculated as probe data based on driving data and is accumulated.

The driving history data comprises link travel time predetermined for travel of each of the road links, and the degree of heavy traffic at various predetermined times on each of the road links. The statistical data can be supplemented with the driving history data. In the present embodiment, the degree of heavy traffic is used as a heavy traffic index indicating the degree of heavy traffic, which is classified as heavy traffic, congestion, or light traffic.

The data recording unit 16 includes disks such as a hard disk, CD, DVD, optical disc, and so forth, which are used to record the various types of data, and also includes heads such as a read/write head for reading or writing various types of data. Also, a memory card or the like can be used with the data recording unit 16. Note that each of the disks, memory card, and so forth constitute an external storage device.

In the present embodiment, the map database, statistics database, driving history database, and so forth are storedin the data recording unit 16, but the map database, statistical database, driving history database, etc. can be located in the information center 51.

The navigation processing unit 17 also comprises a CPU 31 serving as a control device for controlling the entirety of the navigation device 14, and also serving as a computing device, a RAM 32 which is used as a working memory when the CPU 31 performs various types of computations, a ROM 33 in which various types of programs for executing route searching and route guidance to a destination as well as a control program are recorded, and a flash memory which is used to record various types of data, programs, and so forth. The RAM 32, ROM 33, flash memory, etc. constitute an internal storage device.

In the present embodiment, various types of programs can be recorded in the ROM 33, and various types of data can be recorded in the data recording unit 16, but alternatively the programs, and data, and so forth can be recorded on a disk or the like. In this case, the programs, and data can be read out from the disk or the like and written in the flash memory. Accordingly, the programs and data can be updated simply by replacing the disk or the like. Further, a program and data for control by the automatic transmission control unit 10 can be recorded on a disk or disks. Alternatively, the program and data can be received via the communication unit 38 and written into the flash memory of the navigation processing unit 17.

The operating unit 34 provides for correcting the current location at the time of start of travel, for inputting a departure location and a destination, for inputting points to be passed in travel, and for activating the communication unit 38, all by driver operation. A keyboard, mouse, etc, which are disposed independently of the display unit 35, can be also used as the operating unit 34. Another alternative is a touch panel which enables predetermined input operations by touching or clicking on images of various types of keys, switches, buttons, or the like displayed with an image on the screen of the display unit 35.

The various screens on the display unit 35 may show the direction and current location of the vehicle, a map, the determined route, the guidance information for guidance along the determined route, traffic information, the distance to the next intersection in the determined route, and the direction of travel at the next intersection. In addition, the operating guidance, operating menu, and key guidance for the image operating unit, operating unit 34, and voice input unit 36, and the programing of an FM multiplex broadcast station or stations can be displayed.

The voice input unit 36 comprises a microphone, whereby necessary information can be input by voice. Further, the voice output unit 37 comprises a voice synthesizer and speakers, whereby the searched route, guidance information, traffic information, and the like is output from the voice output unit 37, for example, with a voice synthesized by the voice synthesizer.

The communication unit 38 includes a beacon receiver for receiving various types of information such as the current traffic information and common information transmitted from the road traffic information center via an electric beacon, optical beacon, or the like, and an FM receiver for receiving FM multiplex broadcasting from an FM broadcasting station. The traffic information includes heavy traffic information, information on traffic restrictions, parking information, traffic accident information, information re congestion at a rest area, etc. The “common information” includes news, weather forecasts, etc. The beacon receiver and FM receiver may be integrated into a VICS receiver, but can be separate.

The traffic information includes information classification, a mesh number for identifying each mesh, a link number identifying a road link connecting two points, e.g., intersections, and also indicating road slope, i.e. inclines, and link information indicating the content corresponding to each link number. For example, in the event that heavy traffic will be encountered, the link information will include heavy traffic ahead data, including the distance from the start of the road link to the start of the heavy traffic, the degree of heavy traffic, heavy traffic length indicating the distance from the start of the road link to the end of the heavy traffic, and link travel time (the time necessary for travel of the road link).

The communication unit 38 can receive various types of information such as the traffic information and common information from the information center 51 via the network 63 as well as data such as the map data, statistical data, and driving history data.

Accordingly, the information center 51 comprises a server 53, a communication unit 57 connected to the server 53, and a database (DB) 58 serving as an information recording unit. The server 53 comprises a CPU 54 serving as a control device, and also serving as a computation device, RAM 55, and ROM 56. In this case, the same data recorded in the data recording unit 16, e.g., the map data, statistical data, and driving history data, are recorded in the database 58. Further, the information center 51 can provide various types of information such as the current traffic information and common information transmitted from the road traffic information center, and driving history data collected from multiple vehicles (the user's and other vehicles) in real time.

The front monitoring device 48 comprises a laser radar, a millimeter-wave radar, an ultrasonic sensor, or the like, or a combination thereof, and monitors a preceding vehicle (a vehicle traveling ahead) and temporary stop points and obstacles. Also, the front monitoring device 48 detects speed relative to the preceding vehicle, approach speed to a temporary stop point, approach speed to obstacles, and so forth, and calculates the distance between vehicles and inter vehicle time.

The back camera 49 is a CCD device, which is attached with its optical axis directed diagonally downward, captures images of other vehicles traveling behind the user's vehicle, and images of roadside buildings and structures, generates image data for the photographed objects and transmits that image data to the CPU 31. The CPU 31 reads the image data, and recognizes the respective photographed objects within the image by processing the image data. In the present embodiment, a CCD device is used as the back camera 49, but alternatively a C-MOS device or the like can be used.

The navigation system, navigation processing unit 17, CPU 31, CPU 54, server 53, etc. may be integrated into a single computer, maybe independent, or maybe in combination of two or more, and execute various types of programs, process data, and so forth. The data recording unit 16, RAM 32, RAM 55, ROM 33, ROM 56, database 58, and flash memory, may each be a recording medium. A MPU or the like can be also used instead of the CPU 31 and CPU 54, as a computing device.

Next, the basic operation of the navigation system having the above configuration will be described.

First, when the operating unit 34 is operated by the driver to activate the navigation device 14, the navigation initializing processing means 311 of the CPU 31 executes a navigation initializing routine, reads in the current location of the vehicle detected by the GPS sensor 15, and the vehicle direction detected by the direction sensor 18, and also initializes the various types of data. Next, a matching processing means 312 of the CPU 31 executes matching, and pinpoints the current location by determining on which road link the current location is positioned, based on the determined route, the direction and current location which have been read in, and the shapes and array of the respective road links in the vicinity around the current location.

Also in the present embodiment, the matching processing means 312 pinpoints the current location based on the positions of the respective object features within the images captured by the rear camera 49.

Accordingly, the image-recognition processing means 313 of the CPU 31 executes image recognition processing to read in image data from the rear camera 49 and to recognize the object features within that image data. Also, the distance calculation processing means of the CPU 31 calculates the distance from the rear camera 49 to the actual object feature, based on the position of the object feature within the image. Subsequently, the current-location pinpointing means of the matching processing means executes a current-location pinpointing routine to read in the distance, and also to read out the object data from the data recording unit 16 to obtain the coordinates of the object feature, and to pinpoint the current location based on the obtained coordinates and distance.

Also, lane-identification means 315 of the CPU 31 executes a lane identification routine to identify the lane in which the vehicle is traveling, that is to say, the driving lane, by comparing the object feature recognized within the image data with the object feature read out from the data recording unit 16.

If an object to be recognized is formed of a ferromagnetic substance, such as a manhole cover or the like, the lane-identification means reads in the sensor output of the magnetic-field sensor, and determines whether or not there is a manhole cover or the like based on the sensor output, whereby the driving lane can be identified. Further, the current location is detected by using a high-precision GPS sensor 15, whereby the current location can be precisely identified and the driving lane can be detected in this manner also when image processing image data including lane lines. The sensor output of the magnetic-field sensor, the current location, and so forth may be combined as necessary to identify the driving lane.

Subsequently, the basic-information obtaining means 316 of the CPU 31 executes a basic information obtaining routine to obtain the map data by reading out the map data from the data recording unit 16, or by receiving the map data from the information center 51 or the like via the communication unit 38. When obtaining the map data from the information center 51, the basic-information obtaining means downloads the received map data into the flash memory.

Subsequently, the display processing means 317 of the CPU 31 executes a display processing routine to form various screens on the display unit 35. For example, the map display means of the display processing means 317 executes a map display routine to form a map screen on the display unit 35, which map screen shows a map of the vicinity surrounding the detected current location with the position and direction of the vehicle indicated thereon.

Accordingly, the driver can drive the vehicle in accordance with the display of the map, current location, and vehicle direction.

Also, upon the driver using the operating unit 34 to input a destination, the destination setting means 318 of the CPU 31 executes a destination setting routine to set a destination. A departure location can be input and set as necessary. Also, a predetermined point can be registered beforehand, and the registered point can be set as a destination. Subsequently, upon the driver using the operating unit 34 to input searching conditions, the searching conditions setting means 319 of the CPU 31 executes a searching-conditions setting routine to set searching conditions.

Thus, upon the destination and searching conditions being set, the route-searching means 320 of the CPU 31 executes a route-searching routine to read in the current location, destination, searching conditions, and so forth, and also to read out the search data from the data recording unit 16, to search for a route from the departure location, represented by the current location, to the destination using the searching conditions based on the current location, destination, and search data, and to output the route data indicating the route thereby determined. At this time, the route having the lowest sum of link costs becomes the determined route.

In the case where the determined route includes a road with multiple lanes, and also in the case of the driving lane being identified, the route searching means searches the route with lanes as a unit. In this case, lane numbers for the driving lanes are also included in the route data.

Alternatively, the route searching can be performed at the information center 51. In this case, the CPU 31 transmits the current location, destination, searching conditions, and so forth to the information center 51. Upon the information center 51 receiving the current location, destination, searching conditions, etc, the route-searching means 320 of the CPU 54 performs the same route-searching as the CPU 31 by reading out the search data from the database 58, searching for a route from the departure location to the destination based on the current location, destination, and search data, and outputs route data indicating the determined route. Next, the transmission processing means of the CPU 54 executes transmission processing to transmit the route data to the navigation device 14.

Subsequently, the guidance means 321 of the CPU 31 executes a guidance routine to provide route guidance. Accordingly, the route display means of the guidance means 321 executes a route display routine to read in the route data, and to display the determined route on the map screen in accordance with the route data.

In providing the route guidance, in the case that it is necessary to turn the vehicle to the left or right at a predetermined intersection, the predetermined intersection is set as a guidance point, i.e. as a “guidance intersection.” Therefore, the guidance intersection setting means 3211 of the guidance means 321 executes a guidance intersection setting routine, and according to the route data, that is to say, based on the determined route, determines whether or not there is an intersection at which the vehicle must turn to the left or right, and in the case of an intersection at which the vehicle must turn to the left or right, this intersection is set as a guidance intersection.

When a route has been searched in increments of individual lanes, recommended lane setting processing means 3212 of the guidance processing means 321 executes a recommended lane setting routine, and selects and sets as a recommended lane, a lane which is suitable for entering the guidance intersection and a lane suitable for leaving the guidance intersection. The display unit 35 then displays the searched route on a map screen, and also displays an expanded view of the road where the vehicle is traveling in a predetermined region in the map screen, i.e., displays an expanded road view, and lane guidance within the expanded road view. In this case, all lanes inclusive of recommended lane are displayed on the expanded road view.

Next, the voice output processing means of the guidance means executes a voice output routine to output route guidance from the voice output unit 37 by voice. To this end, the route guidance point setting means 3213 of the guidance means 321 executes a route guidance point setting routine to set one or more route guidance points at a preset distance or distances on the near side (the side closer to the user's vehicle), from the guidance intersection on the determined route. Also, point guidance means 3216 of the guidance means 321 executes a point guidance routine, and upon the vehicle reaching each route guidance point, provides route guidance regarding a guidance intersection, the contents of such guidance being set beforehand for each route guidance point, such as the distance from the vehicle to the guidance intersection, a left or right turn at the guidance intersection, and so forth. Also, in the event that a recommended lane has been set, lane guidance processing means of the point guidance means provides lane guidance, the content of which is set beforehand for each route guidance point, such as the recommended lane for approaching the guidance intersection, and recommended lanes beyond the guidance intersection.

Also, guidance point expanded view display means of the guidance means 321 executes a guidance point expanded view display routine, by reading out intersection data, and displaying an expanded view of the guidance intersection in the predetermined region of the map screen before the vehicle reaches the guidance intersection, i.e., display of an expanded view of the intersection, and provides route guidance through the intersection expanded view. In this case, a map of the vicinity around the guidance intersection, searched route, landmarks, such as a facility or the like serving as a reference point at the guidance intersection, are displayed in the intersection expanded view. Also, in the event that a road entering the guidance intersection (hereafter referred to as “entering road”) has multiple lanes or a road exiting the guidance intersection (hereafter referred to as “exiting road”) has multiple lanes, and lane guidance is provided, the guidance point expanded view display means displays a recommended lane on the intersection expanded view. To this end, the intersection data includes data such as the name of the intersection, entering roads, exiting roads, presence/absence of traffic signals, type of traffic signal, and so forth.

In execution of the route guidance point setting routine, the route guidance points are uniformly set based on distance from the guidance intersection, so there may be cases wherein, while providing route guidance for a guidance intersection at the time the vehicle reaches a route guidance point, the vehicle may be driving through an intersection on the near side of the guidance intersection, in which case the content of the route guidance may not match what the driver recognizes. For example, in a case wherein roads intersecting the traveled (determined) route passed in approaching the guidance intersection are used as counted branch elements, the number of roads which the driver recognizes, and the number of roads used as counted branch elements in the route guidance, may not match.

Accordingly, with the present invention, route guidance region changing means 3215 of the guidance means 321 executes a route guidance region change routine such that, in a situation wherein the contents of guidance do not match that which the driver recognizes, route guidance is not provided at the route guidance point and the route guidance region, as previously set by the route guidance determination means 3214, is changed and shifted to the near side or beyond (toward the guidance intersection side).

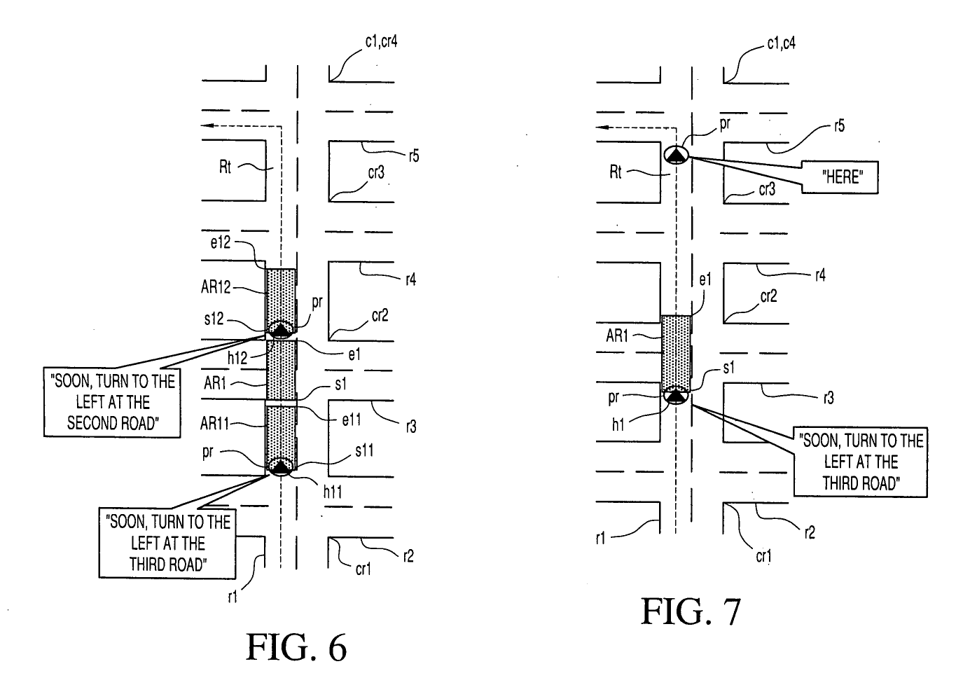

FIG. 5 is a flowchart of operation of the guidance means 321 according to the present embodiment, and FIGS. 6 and 7 illustrate examples of route guidance according to the present invention.

In the drawings, ri (i=1, 2, . . . ) represent roads, and crj (j=1, 2, . . . ) represent intersections, with roads r1 and r2 intersecting at intersection cr1, roads r1 and r3 intersecting at intersection cr2, roads r1 and r4 intersecting at intersection cr3, and roads r1 and r5 intersecting at intersection cr4. Also, Rt represents the determined route, shown as passing over the road r1, turning left at intersection cr4, and turning off to road r5, with the intersection cr4 having been set as guidance intersection c1. Also, pr represents the vehicle current location, and h1 represents the route guidance point as originally set. Upon the vehicle reaching the route guidance intersection h1, route guidance is output for the guidance intersection c1, in the form of a preset message output by voice.

AR1 is the route guidance region formed by route guidance region determination means 3214, within a region between a route guidance start point s1 where the route guidance starts and a route guidance end point e1 where the route guidance ends, and a distance Lar over which the route guidance region AR1 extends is calculated, based on the time from start to end of the route guidance, the vehicle speed, and the content of the route guidance.

First, route guidance determination means of the route guidance region changing means 3215 executes a route guidance routine to determine whether or not the next route guidance is to be provided based on the number of roads passed. In the event that the route guidance is to be performed according to the number of roads, changed condition determination means of the route guidance region changing means executes a change condition determination routine, calculates the route guidance region AR1 from the start to the end of the route guidance, based on the position of the route guidance point h1 and the distance La, so as to determine whether or not a first change condition holds according to whether or not the intersection and the route guidance region AR1 overlap, e.g. the intersection is within the route guidance region AR1.

The intersection and the route guidance region AR1 are determined to be overlapping in the following cases.

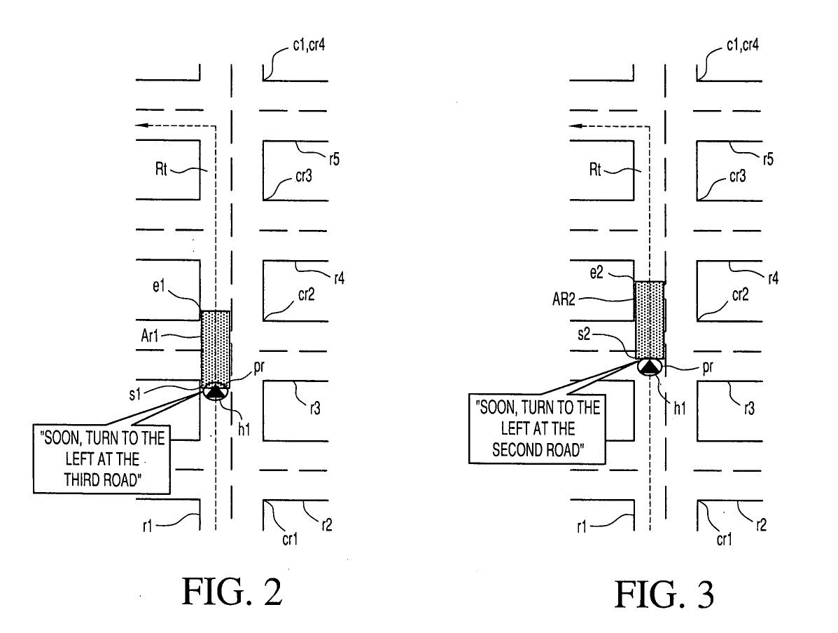

The route guidance start point s1 is set to the near side of the intersection cr2, the route guidance end point e1 is set beyond the intersection cr2, and the vehicle passes through the intersection cr2 while route guidance is being provided, as shown in FIG. 2.

The route guidance start point s1 is set within the intersection cr2, the route guidance end point e1 is set beyond the intersection cr2, and the route guidance starts within the intersection cr2, as shown in FIG. 3.

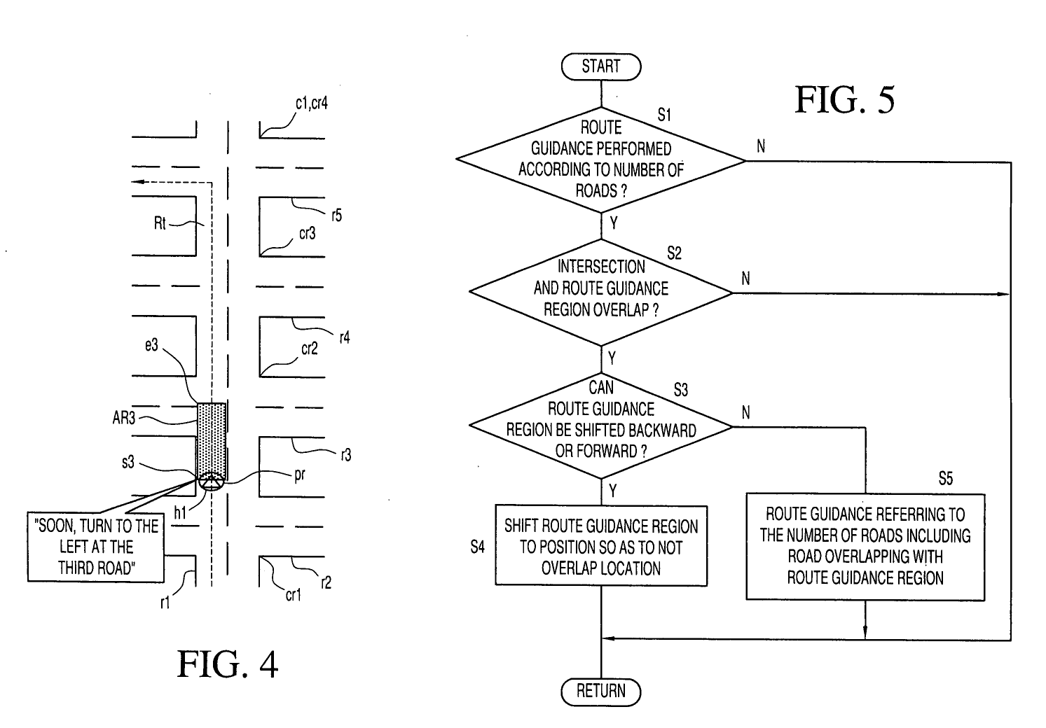

The route guidance start point s1 is set to the near side of the intersection cr2, the route guidance end point e1 is set within the intersection cr2, and the route guidance ends within the intersection cr2, as shown in FIG. 4.

In the event that the intersection and the route guidance region AR1 overlap, such that the first change condition holds, the change condition determination means determines whether or not a second change condition holds, according to whether the route guidance region AR1 can be changed by being moved forward or backward.

In this case, with the distance of the route guidance region AR1 as La, and the distance cr1-cr2 between the intersection cr2 and the adjacent intersection cr1, i.e., the inter-intersection distances L1 and L2, in the event that the distance La is longer than the inter-intersection distance L1, changing the route guidance region AR1 by shifting it to the near side results in a post-shifting route guidance region AR11 overlapping the intersection cr1. Also, in the event that the distance La is longer than the inter-intersection distance L2, changing the route guidance region AR1 by shifting it to the far side results in a post-shifting route guidance region AR12 overlapping the intersection cr3.

In the event that the distance La is equal to or shorter than the inter-intersection distances L1 and L2, the route guidance region AR1 can be changed by moving it forward or backward, but in the event that the distance La is longer than the inter-intersection distances L1 and L2, the route guidance region AR1 cannot be changed by moving it forward or backward.

In the event that the distance La is equal to or shorter than the inter-intersection distances L1 and L2, and the second change condition holds, the region changing means of the route guidance region changing means 3215 executes a region setting routine, and as shown in FIG. 6, changes the route guidance region AR1 so as to not overlap the intersection cr2.

In FIG. 6, AR11 is the route guidance region obtaining by shifting the route guidance region AR1 toward the near side, which route guidance region AR1 is set between the route guidance start point s11 and the route guidance end point e11. In this case, the point guidance means outputs a message such as “soon, turn to the left at the third road” or the like.

AR12 is the route guidance region obtained by shifting the route guidance region AR1 toward the far side, which route guidance region AR12 extends between the route guidance start point s12 and the route guidance end point e12. In this case, the point guidance means outputs a message such as “soon, turn to the left at the second road” or the like.

Note that with the width w of the road r3 intersecting the road r1 at the intersection cr2, the route guidance end point e11 is set at a point on the near side a distance of w/2 from the center of the intersection cr2, and the route guidance start point s12 is set at a point on the far side a distance of w/2 from the center of the intersection cr2.

In the event that the distance La is longer than the inter-intersection distances as L1 and L2, and the second change condition does not hold, the region changing means of the route guidance region changing means 3215 does not change the route guidance region, the point guidance means executes route guidance according to the number of roads r3 through r5, including the road r3 of the intersection cr3 which overlaps the route guidance region AR1, outputs a message such as “soon, turn to the left at the third road” or the like, and outputs no message between the intersections cr1 and cr2 or between the intersections cr2 and cr3. However, so that the vehicle does not pass straight through the intersection cr1, a brief message such as “here” or a sound effect is output immediately before the guidance intersection c1.

To this end, branch element calculation means executes a branch element calculation so as to calculate the number of roads r3 through r5 intersecting with the road r1 at the intersections cr2 through cr4, from the vehicle position pr to the guidance intersection. c1 (three in this case), and route guidance is provided by the point guidance means 3216 based on the number of roads r3 through r5. Note that in this case, the road r5 intersecting the road r1 at the guidance intersection c1 is also a road for which the calculation is performed.

In this way, in the event that the route guidance region AR1 and a predetermined intersection overlap, the route guidance region AR1 is changed to a position so as to not overlap that intersection, thereby avoiding a situation wherein the vehicle is traveling through an intersection at the near side of the guidance intersection c1 while the route guidance is being output. Accordingly, the number of roads intersecting at intersections in advance of the guidance intersection which the driver recognizes, and the number of roads of the route guidance, can be made to match. Consequently, the vehicle can be reliably driven along the determined route Rt.

Next, the flowchart of FIG. 5 will be described.

First, in Step S1, a determination is made as to whether or not route guidance is to reference the number of roads (intersections) in advance of the guidance intersection. In the event that route guidance will reference the number of roads, the routine proceeds to step S2, and if not, the routine returns.

In Step S2, a determination is made regarding whether or not the intersection and route guidance region overlap. In the event that the vehicle will pass through the intersection at the same time the voice guidance is being output, the routine proceeds to step S3, and if not, the routine returns.

In Step S3, a determination is made regarding whether or not the route guidance region can be shifted forward or backward. In the event that the route guidance region can be shifted forward or backward, the routine proceeds to step S4, and if not, the routine returns.

In Step S4, the route guidance region is shifted to a position not overlapping the intersection.

In Step S5, route guidance is provided referring to the number of roads (intersections) including the road (intersection) with which the route guidance region overlaps.

In the above-described embodiment, the branch element calculation means calculates the number of roads (intersections) r3 through r5 as counted branch elements between vehicle current position and the guidance intersection c1; however, the number of intersections cr3 and cr4 between the vehicle position and the guidance intersection c1 maybe the counted branch elements, instead of the roads r3 through r5. In this case, the guidance intersection c1 is also included in the calculated intersections.

The invention may be embodied in other specific forms without departing from the spirit or essential characteristics thereof. The foregoing embodiments, therefore, are to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A route guidance system for a vehicle comprising:
a current-location detecting unit for detecting the current location of the vehicle;
route-searching means for searching to determine a route to a destination based on the detected vehicle current location;
guidance-intersection setting means for setting a guidance intersection based on the determined route;
route guidance point setting means for setting a route guidance point at a predetermined point on the near side, relative to the vehicle, of the guidance intersection, for initiating route guidance regarding the guidance intersection;
route guidance region determination means for calculating a route guidance region from the start to the end of route guidance based on the position of the set route guidance point and the contents of the route guidance, and for determining whether or not the route guidance region overlaps a predetermined intersection between the detected vehicle current location and the guidance intersection; and
route guidance region changing means for changing the route guidance region in the event that the route guidance region is determined to overlap the predetermined intersection.

2. A route guidance system according to claim 1, wherein, when the length of the route guidance region is equal to or shorter than an inter-intersection distance between the intersection with which the route guidance region overlaps and an adjacent intersection, the route guidance region changing means changes the route guidance region.

3. A route guidance system according to claim 1, further comprising point guidance means for providing route guidance based on the number of branch elements from the detected vehicle current location to the guidance intersection, in the event that the length of the route guidance region is longer than an inter-intersection distance between the intersection with which the route guidance region overlaps and an adjacent intersection.

4. A route guidance system according to claim 3, wherein the number of branch elements is the number of roads intersecting the road which the vehicle will travel from the detected vehicle current location to the guidance intersection.

5. A route guidance system according to claim 3, wherein the number of branch elements is the number of intersections from the detected vehicle current location to the guidance intersection.

6. A method of providing route guidance for a driver of a vehicle comprising:
detecting the current location of the vehicle;
searching to determine a route to a destination based on the detected vehicle current location;
setting a guidance intersection based on the determined route;
setting a route guidance point at a predetermined distance on the near side of a guidance intersection, relative to the detected vehicle current location,
providing route guidance regarding the guidance intersection;
calculating a route guidance region from the start to the end of the route guidance, based on the position of the route guidance point and the contents of route guidance;
determining whether or not the calculated route guidance region overlaps a predetermined intersection between the detected vehicle current location and the guidance intersection; and
changing the route guidance region responsive to a determination that the route guidance region overlaps the predetermined intersection.
